(19) United States
(12) Patent Application Publication
(10) Pub. No.: US 2024/0408798 A1
(43) Pub. Date: Dec. 12, 2024

(54) KITS AND MOLDS FOR PREPARING CURED ARTICLES

(71) Applicant: Sanford, L.P., Atlanta, GA (US)

(72) Inventors: Marjavis J. Matthis, Atlanta, GA (US); Stan Chudzik, Atlanta, GA (US); Joseph Wayne Kreft, Atlanta, GA (US); Melanie Kregg, Atlanta, GA (US); Bryan Koepp, Atlanta, GA (US); Lien Phun, Atlanta, GA (US); Jessica Tebbe, Atlanta, GA (US); Michael Jourden, Atlanta, GA (US); Dan Sedlecky, Atlanta, GA (US); Morgan Hinchey, Atlanta, GA (US); Roni Prater, Atlanta, GA (US); Lawrence Wyatt Colvin, Atlanta, GA (US)

(21) Appl. No.: 18/717,627

(22) PCT Filed: Dec. 12, 2022
(86) PCT No.: PCT/US2022/052569

§ 371 Date: Jun. 7, 2024

Related U.S. Application Data
(60) Provisional application No. 63/265,414, filed on Dec. 14, 2021.

(51) Int. Cl. B29C 39/26; B29C 33/00; B29C 33/40; B29C 39/24; B29K 29/00; B29K 31/00; B29K 33/00; B29K 75/00; B29K 83/00; B29L 31/52

(52) U.S. Cl. CPC B29C 39/26; B29C 33/0038; B29C 33/0077; B29C 33/40; B29C 39/24; B29K 2029/04; B29K 2031/04; B29K 2033/08; B29K 2075/00; B29K 2083/00; B29L 2031/5209

(57) ABSTRACT

A kit for preparing a cured article may include first and second casting compositions configured to form a curable composition, and an additive delivery composition for introducing an additive into the curable composition. The additive delivery composition includes a liquid carrier and at least one additive. The liquid carrier may include one or more of polyvinyl acetate, polyvinyl alcohol, or polyacrylate. A mold assembly for preparing a cured article may include a first mold body defining a first mold chamber and a groove surrounding the first mold chamber. The mold assembly further includes a second mold body defining a second mold chamber and a tongue surrounding the second mold chamber. The tongue is receivable into the groove to secure the first and second mold bodies. The first and second mold chambers together define a mold volume configured to receive and shape the curable composition.

### CROSS-REFERENCE TO RELATED APPLICATIONS

This application is a National Stage of International Application No. PCT/US2022/052569, filed Dec. 12, 2022, which claims priority to and the benefit of U.S. Provisional Application No. 63/265,414, filed Dec. 14, 2021, each of which is hereby incorporated by reference.

### BACKGROUND

### 1. Technical Field

The present disclosure relates generally to kits and molds for preparing cured articles from curable compositions.

### 2. Description of the Related Art

Silicone compositions are used to prepare silicone products. For example, liquid or gel silicone compositions may be cast or molded, and cured to form shaped solid silicone products. Silicone compositions may include additives.

Molds may be used to receive and shape the curable compositions.

### SUMMARY

In aspects, the present disclosure describes a kit for preparing a cured article. The kit may include a first casting composition, a second casting composition configured to form a curable composition by mixing with the first casting composition, and an additive delivery composition for introducing an additive into the curable composition. The additive delivery composition includes a liquid carrier and at least one additive. The liquid carrier may include one or more of polyvinyl acetate, polyvinyl alcohol, or polyacrylate.

In aspects, the present disclosure describes a mold assembly for preparing a cured article from a curable composition formed by mixing a first casting composition and as second casting composition. The mold assembly includes a first mold body defining a first mold cavity and a groove surrounding the first mold cavity. The mold assembly further includes a second mold body defining a second mold cavity and a tongue surrounding the second mold cavity. The tongue is receivable into the groove to secure the first mold body and the second mold body to each other. The first mold cavity and the second mold cavity together define a mold volume configured to receive and shape the curable composition when the first mold body and the second mold body are secured to each other.

### BRIEF DESCRIPTION OF THE DRAWINGS

FIG. 1A is a perspective view of an unassembled assembly including a two-part mold including clamping wings and a molded object.

FIG. 1B is a perspective view of the assembly of FIG. 1A partially assembled with two mold bodies in contact.

FIG. 1C is a perspective view of the assembly of FIG. 1A fully assembled with two mold bodies in secured contact.

FIG. 2A is a front view of a two-part mold assembly including a tongue-and-groove joint.

FIG. 2B is a partial perspective view of the two-part mold assembly of FIG. 2A.

FIG. 3A is a perspective view of a two-part mold assembly with a funnel opening to receive a moldable composition.

FIG. 3B is a partial front view of a first mold body of the two-part mold assembly of FIG. 3A.

FIG. 3C is a partial front view showing an object molded in the two-part mold assembly of FIG. 3A.

FIG. 4 is a front view of an unassembled two-part mold assembly including a seal.

It is to be understood that the invention is not limited in its application to the details of construction and the arrangement of components illustrated in the drawings or set forth in the following description.

### DETAILED DESCRIPTION

The present disclosure describes kits and molds for preparing cured articles from curable compositions.

Molds may be used to receive and shape curable compositions to form cured articles, for example, by casting or imprinting a predetermined shape or geometry. Molds may include two or more parts, for example, pull-apart molds. However, molds in which mold halves include only smooth contact interfaces, and which only utilize interfacial contact between the faces of the mold halves may not provide a complete seal against possible leakage or parting line flash from poured in resins into the mold cavity.

Relying solely on the flat face of each mold when assembled, even with friction fit pegs/holes, may not provide a necessary securing force to hold the mold halves together while avoiding leakage. Over time, over time mold material may wear, and peg/hole friction fit may reduce the clamping force provided to the mold halves allowing for the parting line to increase in size and allow for liquid resin leakage and excessive parting line flash.

Mold assemblies according to the present disclosure include one or more features to promote securement or sealing of mold halves to each other. For example, a mold assembly may include clamping appendages, tabs, or wings that securely hold the mold halves together introducing a curable composition (such as a resin) into the mold cavity and when curing commences to prevent the potential leakage and/or excessive parting line flash between the mold halves.

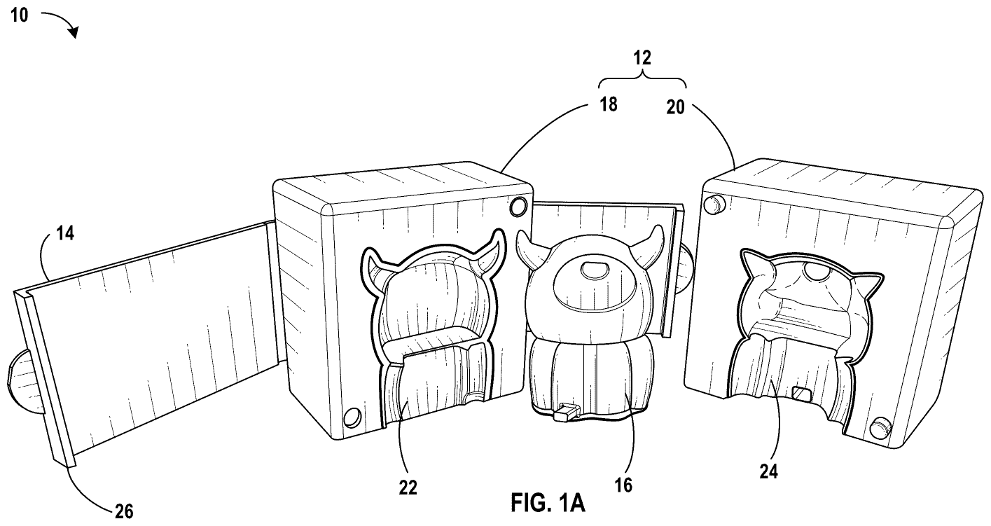

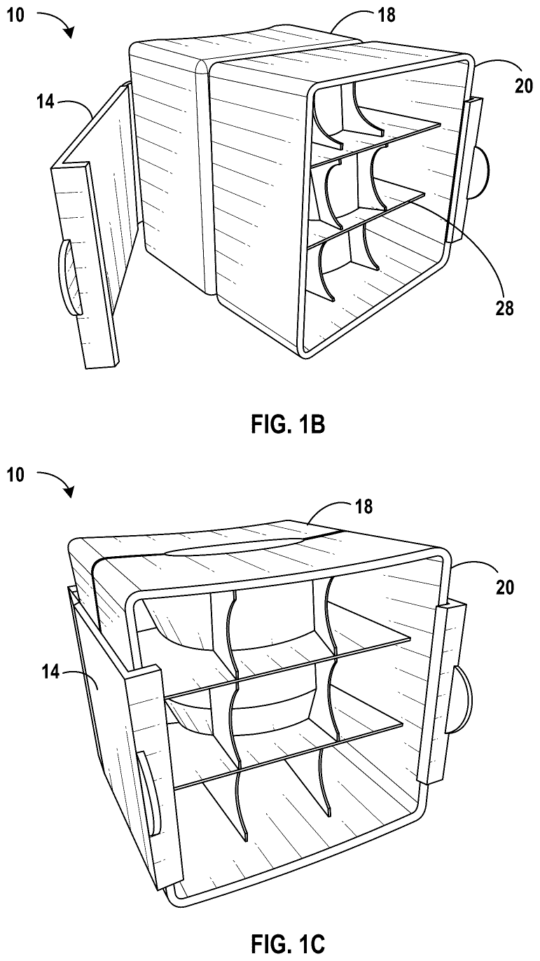

FIG. 1A is a perspective view of an unassembled assembly 10 including a two-part mold 12 including clamping wings 14 and a molded object 16. FIG. 1B is a perspective view of the assembly 10 of FIG. 1A partially assembled with two mold bodies 18 and 20 in contact. FIG. 1C is a perspective view of the assembly of FIG. 1A fully assembled with two mold bodies 18 and 20 in secured contact. The assembly 10 may be used for preparing a cured article from a curable composition formed by mixing a first casting composition and as second casting composition, molded in the assembly 10.

The two mold bodies 18 and 20 define molding surfaces 22 and 24 respectively, which define a three-dimensional shape when the two parts 18 and 20 are in secure contact. In aspects, one or both of the first mold body 18 or the second mold body 20 include one or more of acrylonitrile butadiene styrene (ABS), polystyrene, high impact polystyrene, polyethylene, polypropylene, polycarbonate, or styrene acrylonitrile (SAN). In some aspects, each of the first mold body 18 and the second mold body 20 includes polypropylene. Using polypropylene to form mold bodies may provide an ability to creating a living hinge for the clamping wing due to the material's flexibility, but other materials providing a similar ability may also be used to optionally provide a living hinge between the first mold body 18 and the second mold body 20. For example, the first bold body 18 may remain partially connected to the second mold body 20 via the living hinge.

In aspects, one of the first mold body 18 and the second mold body 20 further includes at least one clamping wing 14. In some such aspects, the at least one clamping wing 14 is unitary with the respective mold body (18 or 20) from which it extends. In FIG. 1, two clamping wings 14 extend from the first mold body 18. In some embodiments, one of the clamping wings 14 may extend from the first mold body 18, while another of the clamping wings may extend from the second mold body 20. In some such aspects, the at least one clamping wing 14 is configured to extend along adjacent sides of the first mold body 18 and the second mold body 20. An end of the at least one clamping wing 14 may define a tab 26 contacting an edge of the other of the first mold body and the second mold body to resist separation thereof.

The clamping wings 14 on one or both sides of the mold assembly 10 may provide sufficient clamping force to hold the two mold halves (mold bodies 18 and 20) together during the introduction of the curable composition into the mold assembly, and during curing.

The clamping wings 14 may apply an appropriate amount of force to maintain enough clamping force between the two mold bodies or halves 18 or 20 to prevent leakage. The clamping wings 14 may flex with specific hinge geometry allowing the wings 14 to be rotated into a locking position around the back of the opposite mold half, drawing that mold half's mating cavity face together with the other mold half cavity face. One, two, or more clamping wings may be provided on one mold half, but both mold halves could have a clamping wing to securely lock the mold halves together. The initial clamping force may range from 1-2 kgf, which may be consistent with the amount of force to pull apart the mold halves when “demolding”.

The clamping wing 14 may securely snap over the rear of the mating mold half, for example, at the tab portion 26. The clamping wing May 14 include a through hole or a blind hold recess snapping around a protruding peg feature of the opposite mold or the clamping force tab as a protruding peg that snaps into a blind hold or through hole. The clamping wing 14 may include a locking snap tab designed or incorporated into one or more alignment protrusions or pegs of the mold halves. The clamping wing 14 may provide uniform closure and clamping force to the mold half faces. The use of secondary clamping devices such as rubber bands, “C” clamps/Quick-grip clamps, may not be needed in the presence of clamps, but can optionally be used. The mold halves may incorporate alignment pegs and recess slots or through holes for assembling and aligning the cavities of both mold bodies or halves 18 and 20 correctly.

A two part casting composition (Part A and Part B) may be introduced into a mixing cup and stirred until thoroughly mixed into a homogenous blend. One of the parts may include a curing catalyst. Additives such as colorants, dyes, pigments, glitter flakes, glow-in-the-dark pigments, or any other additives may be introduced. Once the casting composition is thoroughly mixed, the mixed casting composition may be introduced into the two-component mold assembly (before or after assembling the mold bodies 18 and 20) which defines a mold volume for a shaping the composition into a predetermined geometry. For example, the curable composition may be shaped into a cured article defining a character or a figure, animals, people, action figures (for example, robots, wizards, fairies, goblins, ogres, or griffins), environmental features (for example, rocks, trees, or bushes), tools/utensils (for example, swords, walking sticks, staffs, clubs, or hammers) vehicles (for example, rockets, spaceships, cars, trucks, boats/ships, or airplanes). A volume of a curable composition that is a solid, a putty, or viscous, gelling, or otherwise resistant to flow may be placed between the two bodies 18 and 20 which may be pressed together. A volume of curable composition that is liquid may be introduced through an opening between the bodies 18 and 20, or coated or applied to the surfaces 22 and 24.

One or both of the bodies 18 and 20 may include reinforcing ribs 28, for example, at portions or surfaces away from the molding surfaces 22 and 24.

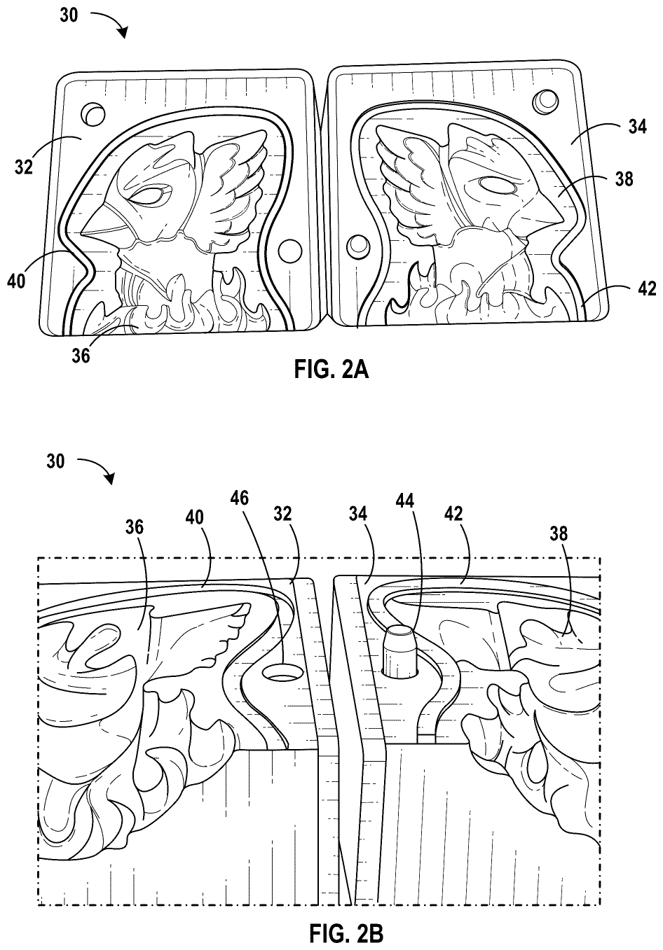

FIG. 2A is a front view of a two-part mold assembly 30 including a tongue-and-groove joint. FIG. 2B is a partial perspective view of the two-part mold assembly 30 of FIG. 2A. The mold assembly 30 may be used for preparing a cured article from a curable composition formed by mixing a first casting composition and as second casting composition. The mold assembly 30 includes a first mold body 32 and a second mold body 34. The mold bodies 32 and 34 may be formed of materials similar to those described with reference to mold bodies 18 and 20 of FIG. 1A.

The first bold body 32 defines a first mold cavity 36 and the second mold body 34 defines a second mold cavity 38. The first mold cavity 36 and the second mold cavity 38 together define a mold volume configured to receive and shape the curable composition when the first mold body 32 and the second mold body 34 are secured to each other. The first mold body 32 defines a groove 40 surrounding the first mold cavity 34. The second mold body 38 defines a tongue 42 surrounding the second mold cavity 38. The tongue 42 is receivable into the groove 40 to secure the first mold body 32 and the second mold 34 body to each other.

In aspects, the tongue 40 and the groove 42 around the mold volume may reduce or prevent leak or flashing of the curable composition at the parting line between the first and second mold bodies to limit the amount of material flashed from curable composition (acting as a “flash trap”). The tongue 40 and the groove 42 may create a mechanical seal preventing the potential for a curable composition from leaking out of the mold volume, and reducing the potential for casting material flash at a parting line of the two mold bodies. For example, the tongue and groove geometry may provide a tortuous path for the curable composition, reducing the amount of material that could be leaked out of the cavity. The tongue and groove geometry may vary in specific dimensions as far as width, height, and depth. For example, a 1 mm width by 1 mm height may be used for the tongue 40, and the groove 32 may be approximately 1 mm deep with an allowance for shrink and/or slightly oversized fit dimension for example 1.1 mm (slightly larger to accommodate material shrinkage from molding process).

In aspects, one of the first mold body 32 and the second mold body 34 defines an alignment peg 44, and the other of the first mold body and the second mold body 34 defines an alignment slot 46 configured to receive the alignment peg 44. The pattern or spacing of alignment pegs may be different for different mold assemblies so that mold halves from different assemblies are not inadvertently combined.

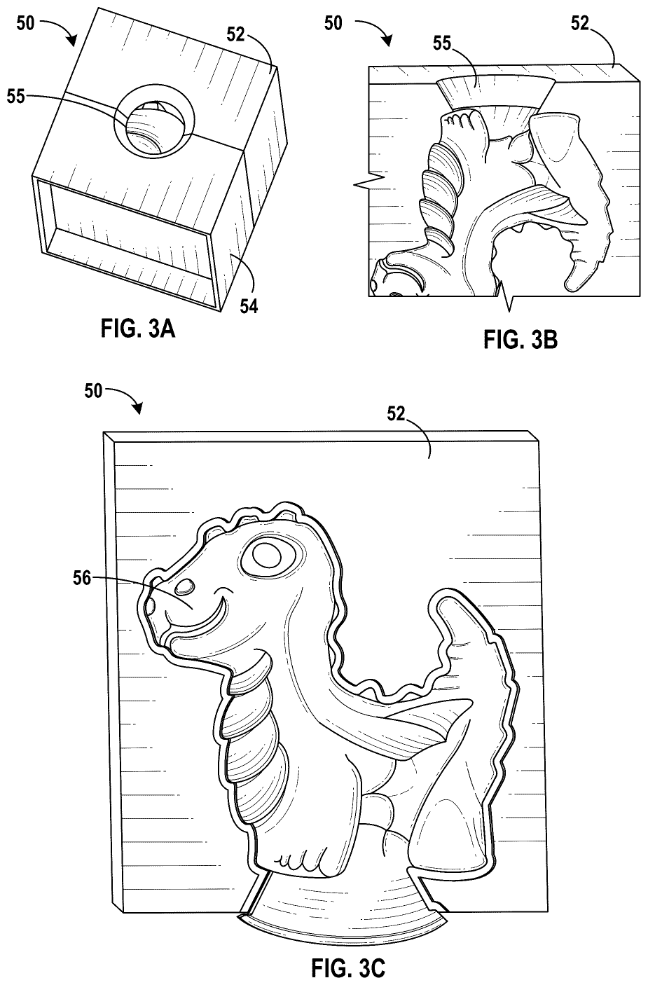

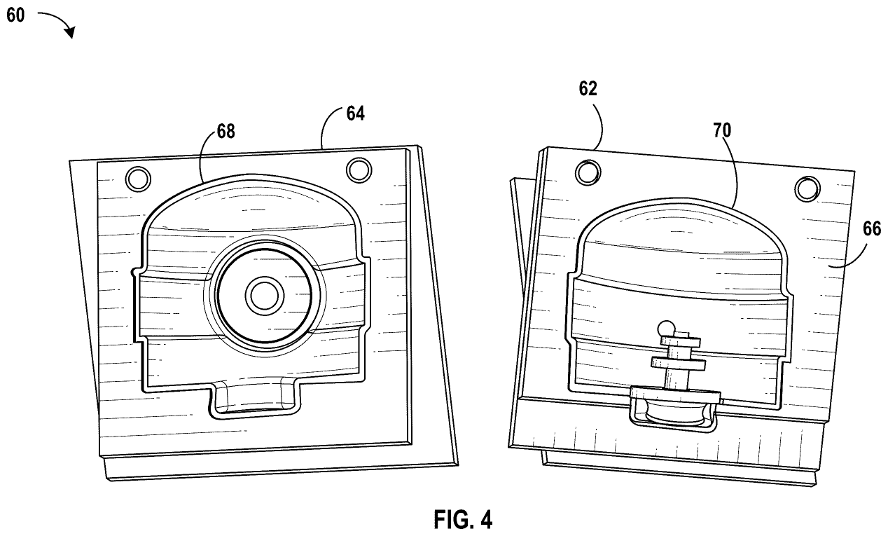

FIG. 3A is a perspective view of a two-part mold assembly 50 with a funnel opening 55 to receive a moldable composition. FIG. 3B is a partial front view of a first mold body 52 of the two-part mold assembly 50 of FIG. 3A. FIG. 3C is a partial front view showing an object 56 molded in the two-part mold assembly of FIG. 3A.

The mold assembly 50 further includes a second mold body 54 that forms a mold volume when in contact with the first mold body 52. The first and second mold bodies 52 and 54 may be formed of a material similar to that described with reference to mold bodies 18 and 20 of FIG. 1A.

In aspects, the mold volume includes the funnel 55 (formed between the first and second mold bodies 52 and 54) continuous with an external surface of the mold assembly to receive and introduce the curable composition into the mold volume.

The funnel geometry may guides curable composition into a larger opening and directs it to a smaller mold cavity opening enabling the ability to reduce mis-pours or pouring outside of the mold and creating a mess from spilling over. The funnel geometry that can be incorporated into the mold halves design may enable a larger diameter pour area introducing the curable composition resin and limiting the amount of potential spillage. The general funnel shape may enable guiding the curable composition into an orifice opening of the mold volume. The angle of the funnel entry may promote control of the flow of the curable composition, may guide the curable composition to the mold volume opening. In aspects, the angle of the funnel may range from 30° to 60° from the cavity opening. In aspects, the height of the funnel may range from 1 mm to as much as 25 mm, but may depend on the component part being cast and the overall size of the mold halves in order to provide a compact shape. In aspects, the overall diameter of the funnel can range from 20 mm to as large as 50 mm or larger depending on casted component size and desired mold size. Diameters smaller than 20 mm may make introducing or pouring a curable composition much more difficult to be accurately dispensed into the mold cavity opening.

FIG. 4 is a front view of an unassembled two-part mold assembly 60 including a seal 66. The mold assembly includes a first mold body 62 and a second mold body 64, similar to other mold assemblies according to the present disclosure. The first and second mold bodies 62 and 64 may be formed of a material similar to that described with reference to mold bodies 18 and 20 of FIG. 1A.

In aspects, one or both of the first mold body 62 or the second mold body 64 includes the seal 66. In some aspects, the seal 66 surrounds a tongue and the groove when the first mold body 62 and the second mold body 64 are secured to each other. For example, the second mold body 64 may define a tongue 68 and the first mold body 62 may define a groove 70 (or vice versa).

The seal 66 may be disposed between the mold bodies 62 and 64. The seal 66 may include thermoplastic elastomer (TPE), foam, or soft elastomers on the face of the mold halves to improve sealing the mold halves together and prevent leakage and reduce parting line flash. The seal 66 may include a soft flexible material such as an elastomer or foam on the mold half face, and provide a compressible surface that enables for improved sealing of the mold halve faces preventing any potential distortion to the mold faces, thus reducing or preventing the mold halves from providing a path for leakage.

The seal 66 may act as or be in the form of a gasket around the mold cavity. The thickness of the sealing materials can range from 0.5 mm to as much as 2 mm, and a preferable thickness is 1 mm. The sealing material of the seal 66 can be designed as a ring around the perimeter of the mold face like an “O” Ring. The seal 66 may have dimensions at least 1 mm wide, but can be as little as 0.5 mm wide and as large as 10 mm wide depending on the area of the mold face itself. The sealing material may not be in the form of a ring, and can be a larger predetermined surface area covering more surface area of the mold face providing more squeezable sealing between mold halves cavity faces. Reducing leakage may reduce or prevent the cured article from being short of a sufficient volume of the curable composition to fill the mold volume for desired casting results. The sealing material may also prevent leakage due to mold damage (scraps and scuff marks from repeated usage, such as mold face surface damage) or mold warping between the two mold halves at the parting line splitting the two mold halves.

While features such as a clamping wing, a tongue-and-groove, alignment pins, a funnel, and a seal are separately described with reference to different assemblies, it is understood that any number of these features may be used together in any mold assembly.

Any suitable curable composition may be used to form molded articles using any suitable mold assembly according to the present disclosure.

Solid silicone articles and products may be formed by curing precursor formulations, for example, curable silicone compositions. One or additives may be added to curable silicone compositions, for example, colorants or other agents, to impart predetermined characteristics to the final cured silicone product. The use of powder additives may not be desirable, in view of certain disadvantages associated with powder additives for users or manufacturers. For example, powder additives may unintentionally be dispersed or suspended in the ambient atmosphere, and may be unintentionally inhaled.

Further, adding certain types of additives directly to a curable silicone composition may present disadvantages. For example, liquid colorants, or food coloring, to silicone formulations may not be well mixed or result in different phases rather than being uniformly incorporated into silicone formulations.

Additive delivery compositions according to the present disclosure may be used as delivery systems for introducing additives into curable silicone compositions. Instead of adding powder additives, or other additives susceptible to dispersion or suspension in the air, additives may be dissolved, suspended or mixed with a liquid carrier to form an additive delivery composition. The additive delivery composition can be stored, transported, and handled without resulting inhalation of particles or other disadvantages. For example, the additive delivery composition may be compounded, mixed, or introduced into the curable silicone compositions. Further, liquid additives may be introduced into the additive delivery compositions, which may themselves be uniformly mixable with curable silicone compositions, so that ultimately the liquid additives (for example, food coloring) are well mixed and uniformly incorporated into the curable silicone compositions, and ultimately, the cured silicone product.

In aspects, the present disclosure describes a kit for preparing a cured article. The kit may include a first casting composition, a second casting composition configured to form a curable composition by mixing with the first casting composition, and an additive delivery composition for introducing an additive into the curable composition. The additive delivery composition includes a liquid carrier and at least one additive. The liquid carrier may include one or more of polyvinyl acetate, polyvinyl alcohol, or polyacrylate.

In aspects, the kit further includes a mold defining a mold volume configured to receive and shape the curable composition.

In aspects, the kit further includes a mixing vessel configured to receive and mix two or more of the first casting composition, the second casting composition, or the additive delivery composition.

In aspects, the kit further includes a mixing apparatus configured to mix two or more of the first casting composition, the second casting composition, or the additive delivery composition. The mixing apparatus may include one or more of a spoon, a stirrer, or a rod. In aspects, the kit further includes a housing containing one or more of the first casting composition, the second casting composition, the additive delivery composition, or the mold. In some aspects, the housing contains each of the first casting composition, the second casting composition, the additive delivery composition, and the mold.

In aspects, the kit further includes a first container containing the first casting composition. In aspects, the kit further includes a second container containing the second casting composition. In aspects, the kit further includes a third container containing the first container and the second container. In aspects, the kit further includes a fourth container containing the additive delivery composition. In aspects, the housing contains one or more of the first container, the second container, the third container, or the fourth container. In some aspects, the housing contains each of the first container, the second container, the third container, and the fourth container.

In aspects, one or more of the first container, the second container, the third container, or the fourth container include a bag, a pouch, a tub, a rigid bottle, a squeeze bottle, or a syringe.

The present disclosure provides further variations of the mold assemblies. Mold components may be formed by injection molding of polypropylene resin. The mold halves could also be vacuum formed/thermoformed halves with peg and slot alignment/connecting methods to enable cost reduction. The mold halves could be connected together with a hinge (living hinge or mechanical pin-type hinge) to have a rotatable clam-shell mold feature. Another alternative connection option would be to utilize a twist-locking mechanism to secure the molds together for the pour and curing phase. The tongue and groove geometry could be done right at the perimeter of the casted component or can be offset from the outside parameter profile of the casted component in various dimension depending on component design/geometry that can accommodate casted component features like through holes. The geometry can be of alternative shapes other than square/rectangular profiles. Circular/cylindrical arcs or triangular profiles can be utilized for the tongue and groove profile. The curable composition does not have to be poured into the mold cavity from a mixing cup, and instead may be introduced using an alternative casting resin delivery system that injects the resin into the mold cavity like that from a syringe or epoxy dual barrel syringe system. Pouches of Part A and Part B casting compositions may be placed in a larger pouch that enables to be mixed together and dispensed out while reducing or preventing a mess when mixing and dispensing into the mold cavity. The mold may hold accessories that enable other features to be incorporated into the mold cavity, such as suspending lights (LED/LCD, incandescent lights), power supply, or other rigid or soft structural or functional inserts. Another accessory would include the ability to insert connecting mechanisms so that components can be snapped together.

Kits and mold assemblies according to the disclosure may be used to form and receive a curable composition within a mold volume, so that the mold volume imparts a predetermined shape to the curable composition to form a cured article. Additive delivery compositions may be used to introduce one or more additives into the curable composition, and ultimately into the cured articles.

In aspects, the present disclosure describes an additive delivery composition for introducing an additive into a curable silicone composition may include a liquid carrier and at least one additive. The liquid carrier may include one or more of polyvinyl acetate, polyvinyl alcohol, or polyacrylate.

In aspects, the present disclosure describes a method of adding an additive to a curable silicone composition. The method includes adding the additive delivery composition to the curable silicone composition.

In aspects, the present disclosure describes a method of forming an additive delivery composition for introducing an additive into a curable silicone composition. The method includes adding at least one additive to a liquid carrier comprising one or both of polyvinyl acetate or polyvinyl alcohol.

In aspects, the present disclosure describes a method of adding an additive to a curable silicone composition. The method includes adding an additive delivery composition including one or both of polyvinyl acetate or polyvinyl alcohol to the curable silicone composition. The method includes adding at least one additive to the curable composition.

In aspects, the present disclosure describes a curable silicone composition include up to 15% by weight of an additive delivery composition including at least one additive and a liquid carrier including one or both of polyvinyl acetate or polyvinyl alcohol.

In aspects, the present disclosure describes a cured silicone product formed by curing the curable silicone composition.

The precursor curable compositions may include liquid or gel silicone compositions, for example, compositions that are cast or molded in a predetermined shape. The curing may be a result of cross-linking, chemical, or catalyzed interactions between two or more components of the silicone compositions, or a by being exposed to an energy source, such as radiation curing or thermal curing. The cured composition will include additives introduced via the additive delivery composition.

In aspects, curing may be initiated by mixing a two-part formulation. In some such aspects, the curing may be performed at room temperature. In some such aspects, the additive delivery composition may be added, introduced, or mixed, into one or both parts (for example, Part A and Part B) of the two-part formulation separately, before the parts are mixed to initiate curing. In other aspects, the additive delivery composition may be added to a mixed two-part composition shortly after mixing and before curing has substantially progressed. In some aspects, a first additive delivery composition may be added to at least one of the two parts before mixing, and a second additive delivery composition may be added to the mixture shortly after mixing, for example, before curing has substantially progressed.

In some aspects, the same additive delivery composition may be added in the same or different concentrations to each part of the two-part formulation before mixing. In other aspects, different additive delivery compositions (for example, differing in the liquid carrier, or qualitatively or quantitatively differing in the additives present) may be added to the different parts of the formulation.

In some aspects, whether a single-part, two-part, or multi-part formulation is used, the additive delivery composition may be added in stages, and in the same or different volumes or concentrations, for example, before or during curing. In some aspects, different additive delivery compositions may be introduced into the formulation at different stages (before curing or during curing).

In aspects, the liquid carrier includes an aqueous carrier, or an organic carrier. In some aspects, the liquid carrier includes one or more of a polyvinyl alcohol solution, a polyvinyl acetate solution, or a polyacrylate solution.

In some aspects, the additive delivery composition includes a combination of polyvinyl alcohol and polyvinyl acetate. Additives, colorants, or special effects may be added to the additive delivery composition, and the additive delivery composition with one or more additives may be added to a curable silicone composition for curing into a cured silicone product. Thus, providing colorants or special effect additives in the additive delivery compositions allows imparting predetermined colors, special effects, or other properties to the silicone products.

In aspects, a polyvinyl acetate emulsion can be used as a ‘solvent’ or carrier in order to incorporate additives into a curable silicone composition.

In aspects, the liquid carrier is an aqueous carrier or an organic carrier.
In aspects, the additive delivery composition includes a solution, a mixture, an emulsion, or a suspension of one or more of polyvinyl acetate, polyvinyl alcohol, or polyacrylate.

In aspects, the at least one additive includes a powder additive, a solid additive, a gel additive, or a liquid additive.

In aspects, the at least one additive comprises a food colorant. In some such aspects, the food colorant is a liquid colorant or a powdered colorant.

In aspects, the at least one additive comprises a special effect additive.

It was surprisingly found that the cure time as well as the texture of the final silicone product is not impacted, even if up to 15 wt. % of the polyvinyl acetate or polyvinyl alcohol solution is incorporated into the curable silicone formulation.

In aspects, an additive is first mixed with a liquid carrier to form the additive delivery composition, and the additive delivery composition is then mixed with the curable silicone composition. The liquid carrier may include one or both of a polyvinyl alcohol or a polyvinyl acetate solution, emulsion, or suspension.

In aspects, an additive and a liquid carrier are simultaneously mixed with the curable silicone composition, and the presence of the liquid carrier facilitates the incorporation of the additive into the curable silicone composition.

### Aspects

Aspect 1. A kit for preparing a cured article, the kit including:
a first casting composition;
a second casting composition configured to form a curable composition by mixing with the first casting composition;
an additive delivery composition for introducing an additive into the curable composition, the additive delivery composition including:
   a liquid carrier including one or more of polyvinyl acetate, polyvinyl alcohol, or polyacrylate, and
   at least one additive.

Aspect 2. The kit of aspect 1, wherein the liquid carrier is an aqueous carrier or an organic carrier.

Aspect 3. The kit of aspect 1 or 2, wherein the additive delivery composition includes a solution, a mixture, an emulsion, or a suspension of one or more of polyvinyl acetate, polyvinyl alcohol, or polyacrylate.

Aspect 4. The kit of any one of aspects 1 to 3, wherein the at least one additive includes a powder additive, a solid additive, a gel additive, or a liquid additive.

Aspect 5. The kit of any one of aspects 1 to 4, wherein the at least one additive includes a food colorant.

Aspect 6. The kit of any one of aspects 1 to 5, wherein the at least one additive includes a special effect additive.

Aspect 7. The kit of any one of aspects 1 to 6, wherein the curable composition includes a silicone or a polyurethane.

Aspect 8. The kit of any one of aspects 1 to 7, further including a mold defining a mold volume configured to receive and shape the curable composition.

Aspect 9. The kit of any one of aspects 1 to 8, further including a mixing vessel configured to receive and mix two or more of the first casting composition, the second casting composition, or the additive delivery composition.

Aspect 10. The kit of any one of aspects 1 to 9, further including a mixing apparatus configured to mix two or more of the first casting composition, the second casting composition, or the additive delivery composition.

Aspect 11. The kit of aspect 10, wherein the mixing apparatus includes one or more of a spoon, a stirrer, or a rod.

Aspect 12. The kit of any one of aspects 1 to 11, further including a housing containing one or more of the first casting composition, the second casting composition, the additive delivery composition, or the mold.

Aspect 13. The kit of aspect 12, wherein the housing contains each of the first casting composition, the second casting composition, the additive delivery composition, and the mold.

Aspect 14. The kit of any one of aspects 1 to 13, further including a first container containing the first casting composition.

Aspect 15. The kit of any one of aspects 1 to 14, further including a second container containing the second casting composition.

Aspect 16. The kit of any one of aspects 1 to 15, further including a third container containing the first container and the second container.

Aspect 17. The kit of any one of aspects 1 to 16, further including a fourth container containing the additive delivery composition.

Aspect 18. The kit of any one of aspects 14 to 17, wherein the housing contains one or more of the first container, the second container, the third container, or the fourth container.

Aspect 19. The kit of aspects 18, wherein the housing contains each of the first container, the second container, the third container, and the fourth container.

Aspect 20. The kit of any one of aspects 14 to 17, wherein one or more of the first container, the second container, the third container, or the fourth container include a bag, a pouch, a tub, a rigid bottle, a squeeze bottle, or a syringe.

Aspect 21. A mold assembly for preparing a cured article from a curable composition formed by mixing a first casting composition and as second casting composition, the mold assembly including:
a first mold body defining a first mold cavity and a groove surrounding the first mold cavity; and
a second mold body defining a second mold cavity and a tongue surrounding the second mold cavity,
wherein the tongue is receivable into the groove to secure the first mold body and the second mold body to each other,
wherein the first mold cavity and the second mold cavity together define a mold volume configured to receive and shape the curable composition when the first mold body and the second mold body are secured to each other.

Aspect 22. The mold assembly of aspect 21, wherein one or both of the first mold body or the second mold body include one or more of acrylonitrile butadiene styrene (ABS), polystyrene, high impact polystyrene, polyethylene, polypropylene, polycarbonate, or styrene acrylonitrile (SAN).

Aspect 23. The mold assembly of aspect 22, wherein each of the first mold body or the second mold body includes polypropylene.

Aspect 24. The mold assembly of any one of aspects 21 to 23, wherein one of the first mold body and the second mold body further includes at least one clamping wing.

Aspect 25. The mold assembly of aspect 24, wherein the at least one clamping wing is unitary with the respective mold body from which it extends.

Aspect 26. The mold assembly of aspects 24 or 25, wherein the at least one clamping wing is configured to extend along adjacent sides of the first mold body and the second mold body, and wherein an end of the at least one clamping wing defines a tab contacting an edge of the other of the first mold body and the second mold body to resist separation thereof.

Aspect 27. The mold assembly of any one of aspects 21 to 26, wherein the mold volume includes a funnel continuous with an external surface of the mold assembly to receive and introduce the curable composition into the mold volume.

Aspect 28. The mold assembly of any one of aspects 21 to 27, wherein one or both of the first mold body or the second mold body includes a seal.

Aspect 29. The mold assembly of any one of aspects 21 to 28, wherein the seal surrounds the tongue and the groove when the first mold body and the second mold body are secured to each other.

Aspect 30. The mold assembly of any one of aspects 21 to 29, wherein one of the first mold body and the second mold body defines an alignment peg, and wherein the other of the first mold body and the second mold body defines an alignment slot configured to receive the alignment peg.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A kit for preparing a cured article, the kit comprising:
a first casting composition;
a second casting composition configured to form a curable composition by mixing with the first casting composition;
an additive delivery composition for introducing an additive into the curable composition, the additive delivery composition comprising:
a liquid carrier comprising one or more of polyvinyl acetate, polyvinyl alcohol, or polyacrylate, and
at least one additive.

2. The kit of claim 1, wherein the liquid carrier is an aqueous carrier or an organic carrier.

3. The kit of claim 1, wherein the additive delivery composition comprises a solution, a mixture, an emulsion, or a suspension of one or more of polyvinyl acetate, polyvinyl alcohol, or polyacrylate.

4. The kit of claim 1, wherein the at least one additive comprises a powder additive, a solid additive, a gel additive, or a liquid additive.

5. The kit of claim 1, wherein the curable composition comprises a silicone or a polyurethane.

6. The kit of claim 1, further comprising one or more of:
(i) a mold defining a mold volume configured to receive and shape the curable composition;
(ii) a mixing vessel configured to receive and mix two or more of the first casting composition, the second casting composition, or the additive delivery composition; or
a mixing apparatus configured to mix two or more of the first casting composition, the second casting composition, or the additive delivery composition.

7. The kit of claim 6, wherein the mixing apparatus comprises one or more of a spoon, a stirrer, or a rod.

8. The kit of claim 6, further comprising a housing containing one or more of the first casting composition, the second casting composition, the additive delivery composition, or the mold.

9. A mold assembly for preparing a cured article from a curable composition formed by mixing a first casting composition and as second casting composition, the mold assembly comprising:
a first mold body defining a first mold cavity and a groove surrounding the first mold cavity; and
a second mold body defining a second mold cavity and a tongue surrounding the second mold cavity,
wherein the tongue is receivable into the groove to secure the first mold body and the second mold body to each other,
wherein the first mold cavity and the second mold cavity together define a mold volume configured to receive and shape the curable composition when the first mold body and the second mold body are secured to each other.

10. The mold assembly of claim 9, wherein one or both of the first mold body or the second mold body comprise one or more of acrylonitrile butadiene styrene (ABS), polystyrene, high impact polystyrene, polyethylene, polypropylene, polycarbonate, or styrene acrylonitrile (SAN).

11. The mold assembly of claim 10, wherein each of the first mold body or the second mold body comprises polypropylene.

12. The mold assembly of claim 9, wherein one of the first mold body and the second mold body further comprises at least one clamping wing.

13. The mold assembly of claim 12, wherein the at least one clamping wing is configured to extend along adjacent sides of the first mold body and the second mold body, and wherein an end of the at least one clamping wing defines a tab contacting an edge of the other of the first mold body and the second mold body to resist separation thereof.

14. The mold assembly of claim 9, wherein the mold volume comprises a funnel continuous with an external surface of the mold assembly to receive and introduce the curable composition into the mold volume.

15. The mold assembly of claim 9, wherein one or both of the first mold body or the second mold body comprises a seal.
